(19) United States
(12) Patent Application Publication
(10) Pub. No.: US 2003/0080043 A1
(43) Pub. Date: May 1, 2003

(54) Filter cell design

(76) Inventors: Naren Renganath, Burlington, MA (US); Stephen Proulx, Boxboro, MA (US)

Correspondence Address: MILLIPORE CORPORATION, 290 CONCORD ROAD, BILLERICA, MA, 01821, US

(21) Appl. No.: 10/269,279

(22) Filed: Oct. 11, 2002

Related U.S. Application Data
(60) Provisional application No. 60/340,897, filed on Oct. 30, 2001.

(51) Int. Cl. B01D 29/41

(52) U.S. Cl. 210/347; 210/486; 210/490

(57) ABSTRACT

The present invention provides a device for the filtration of fluids using porous fibrous filtration media. The present invention comprises a central support layer, one or more layers of porous media mounted on each side of the central support layer and an elastomeric seal on the outer edge of the support/media that forms a liquid tight seal so that all fluid must flow through the media before reaching the central support layer.

The present invention relates to porous filters, often referred to as pad filters. More particularly, it relates to porous cellulosic or thermoplastic fiber/filler type filters, typically arranged in a stacked disk format and a means for forming an elastomeric seal on at least the outer rim of the filter.

### BACKGROUND OF THE INVENTION

Filtration of fine sized particles and contaminants from fluids has been accomplished by the use of various porous filter media through which the contaminant fluid is passed. Of particular interest are biological broths used in the manufacture of proteins, monoclonal antibodies and other such biopharmaceuticals. Another area of interest is in the filtration of grape juice for the manufacture of wine, the filtration of various other fruit juices and the filtration of beer.

To function as a filter, the media must allow the fluid, typically water or an aqueous based fluid to pass through the media while retaining the particulate contaminant. This retention of contaminant is accomplished through the operation of different distinct mechanisms of filtration. The first is a simple mechanical filtration and the second is electrokinetic particle capture and adsorption. Other mechanisms may also play a lesser role in the retention of the contaminants.

In mechanical filtration, a particle is removed by physical entrapment when it attempts to pass through a pore smaller than itself. In electrokinetic capture, the particle collides with a surface within the filter and is retained on the surface by short-range attractive forces.

The traditional device for this filtration/clarification step has been to use a series of porous pads, formed of a blend of natural and/or synthetic fibers such as thermoplastic fibers like polyethylene and polypropylene and natural fibers such as cellulose, cellulosic derivatives such as cellulose acetate, rayon, cotton, wood pulp and one or more fillers or filtration aids such as diatomaceous earth, silica, carbon, talc, perlite, molecular sieves, clays, etc. and mixtures thereof. See U.S. Pat. Nos. 2,788,901 3,158,532, 4,305,782. To enhance the electrokinetic capture mechanism, the use of various charge modifiers has been suggested to control the zeta potential of the sheet constituents and maximize performance of the device. Typically these are cationic modifiers since most naturally occurring contaminant surfaces are anionic at the pH of the fluids used. See U.S. Pat. Nos. 4,305,782, 4,007,113, 4,007,114 and 5,085,784.

The filters are made as either mats or supported cells. Typically, they are supported on each face of a lenticular central support. The inner and outer edges are bonded/sealed to the support so that all fluid must pass through the media before reaching the exit channel that is centrally located in the support. The edges are sealed with metal or hard plastic rims or compression clamps or bands and the like that compress the media in the area where the seals are located.

The cells may be used singularly or in groups. See U.S. Pat. Nos. 2,788,901 and 5,085,784. Typically, the filter cells are used in groups (generally of 16 to 20 per group) stacked upon a central core within a housing. Fluid to be filtered enters the bottom or side adjacent the bottom of the housing and flows through the filter media to the central channel of the support and then to the central core where it is removed from the housing through an outlet in the bottom or side of the housing.

The media in use swells as it makes contact with the fluid stream. The use of the lenticular support has in large part been to compensate for this swelling and the additional weight that the media takes on through the fluid absorption. In addition, the lenticular support has been made relatively robust with various crosstie designs to minimize the resultant warping and distortion that occurs to the support because of the swelling and weight of the media.

Moreover, the swelling has to be factored in to the spacing of the pads in a housing, thus limiting the number of cells that can be used in any given housing and the overall filtration capacity of the pad system.

Lastly, the media is known to crack or distort. This allows fluid to bypass the media, reducing filter efficiency.

What is desired is a device that provides for an improved filter cell design that minimizes the effects of the media swelling. Additionally, it is desired to have a device that reduces the need for wide spacing between the adjacent cells due to the swelling and/or which reduces or eliminates the need for the lenticular support. The present invention provides such a device.

### SUMMARY OF THE INVENTION

The present invention provides a device for the filtration of fluids using porous fibrous filtration media with improved performance. The present invention comprises one or more layers of porous media, a central support layer and an outside elastomeric edge seal.

In a preferred embodiment, the device is comprised of a series of disks or cells. Each disk has a central core and one or more outwardly radiating arms and one or more porous layers arranged on the outer surface of the one or more arms. A spacer means is provided within or between the inner surfaces of the one or more flanges to provide a channel for fluid that has passed through the media to travel to the central opening that forms a vertical conduct to the outlet from the system. A seal is formed on the inner edge of the media adjacent the central core. A seal on the outer edge of each disk is formed of an elastomeric material that expands and contracts with the media as it swells in the liquid.

Alternatively, one or more layers of the porous media is formed around an inner porous core and the upper and lower edges of the media are sealed by an elastomeric seal to form a cartridge type device.

### IN THE DRAWINGS

FIG. 1 shows a disk according to a first embodiment of the present invention.

FIG. 2 shows a second embodiment of a disk according the present invention in cross section.

FIG. 3 shows an embodiment of a support according to an embodiment of the present invention.

FIG. 4 shows a first embodiment of an assembly of disks according to the present invention in cross section.

FIG. 5 shows an additional embodiment of the present invention in cross sectional view.

### DETAILED DESCRIPTION OF THE INVENTION

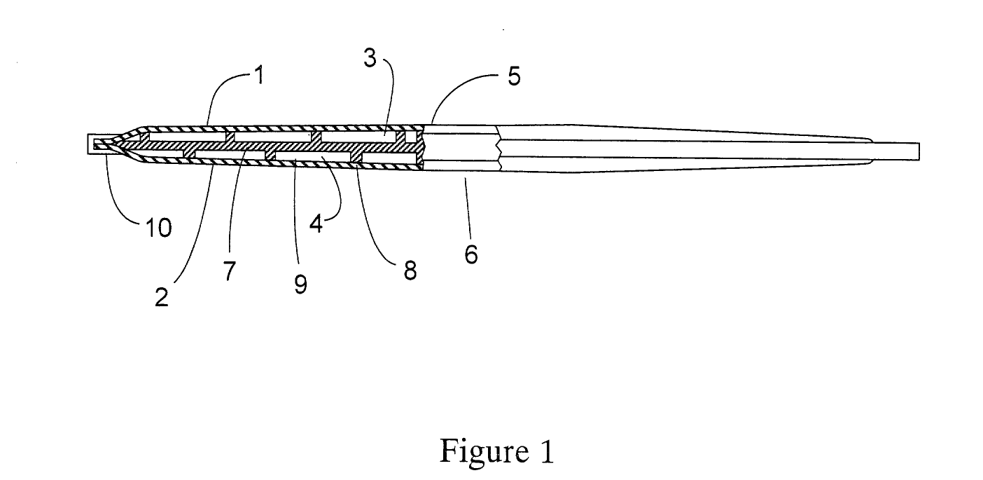

FIG. 1 shows a filter disk of porous fibrous media according to one embodiment of the present invention. In this device, there are two layers of fibrous media 1, 2 attached to opposite surfaces 3,4 of a lenticular support disk 5. While one layer is shown on each side, more than one layer can be used. The support disk 5 is formed of a central aperture 6 from which a support arm 7 extends outwardly and radially. A series of spacers or nubs 8 extend from the arm and support the media layers 1, 2. A space between the nubs 8 forms a channel 9 that is in fluid communication with the central aperture 6. The outer peripheral edges of the porous media 1, 2 and the arm 7 are sealed by an elastomeric edge 10 that provides a flexible, integral, fluid-tight seal to the outer edge of the device. Therefore, all fluid entering the channel 9 must do so by having passed through the layer of porous media 1, 2 and the support arm 7.

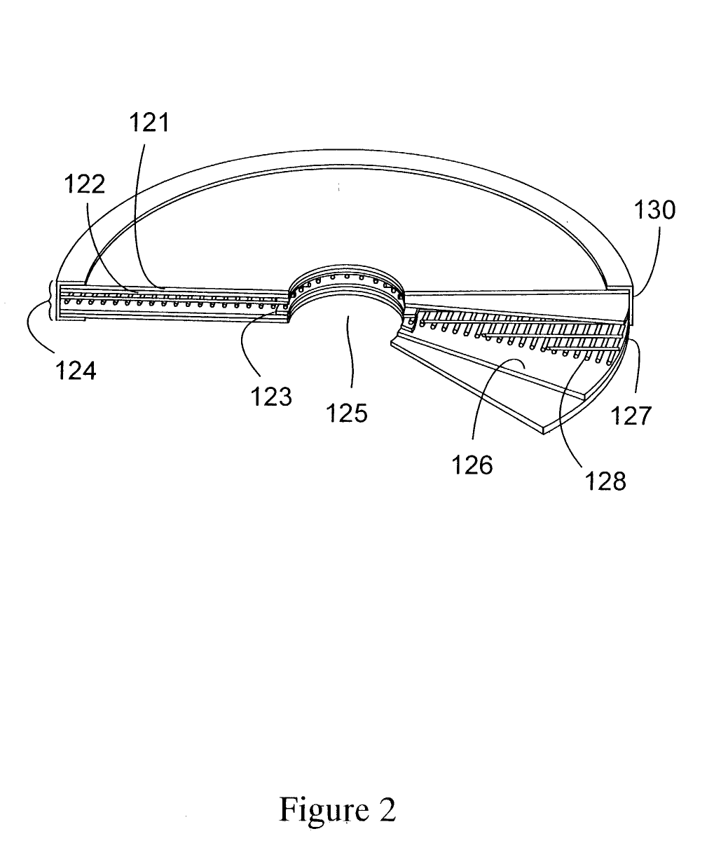

FIG. 2 shows another preferred embodiment of the present invention. In this device, there are one or more layers of fibrous media 121, two layers being shown, attached to opposite surfaces 122, 123 of a central support and support layer 124. This layer 124 is unlike the lenticular support of FIG. 1. It is formed of a relatively flat support such as a screen, preferably a bi-directional screen or a perforated sheet of material such as a sheet of plastic or metal having a series of holes formed throughout its surface or the radially projecting disks. If desired, when using a perforated sheet, one may add some corrugations or discrete standoffs or spacer points to the sheet to create the spacing needed for the easy flow of fluid from the media to the outlet of the device. Alternatively, one can use two layers of perforated sheets with spacer points or standoffs formed on the surfaces of one or both layers that face the opposite layer so as to form a flat (non-lenticular) support with a channel in the center that is in fluid communication with the outlet. This design is explained in further detail in co-pending application PCT/US01/13533 filed Apr. 27, 2001.

In the embodiment shown in FIG. 2, the use of the preferred bi-directional screen is shown. In the support 124 is formed a central aperture 125. The space 126 between the upper support layer 127 and the lower support layer 128 forms a channel that is in fluid communication with the central aperture 125. The outer peripheral edges of the porous media 121 and the support layer 124 are sealed by an edge 130 that provides an integral fluid-tight seal to the outer edge of the device. Optionally, and preferably, a disk 131 is interposed between the support layer 124 and the downstreammost layer of the fibrous media 121 around the central aperture 125. This disc 131 prevents any collapse of the media 121 into the support layer 124 as the inner edge of the assembly is compressed to form a liquid tight seal around the inner periphery of the media. Therefore all fluid entering the core must do so by having passed through the layer of porous media and the support layer.

Alternatively, one may injection mold or adhere a disc 131 to the central aperature 125 to maintain it in place. Another embodiment is to integrate it into the porous media, such as by casting it in place with the formation of the media.

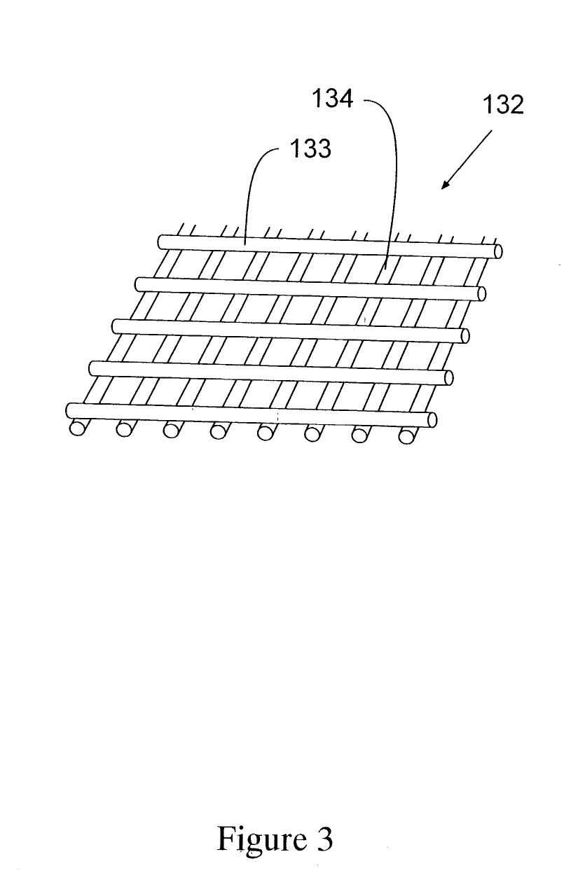

FIG. 3 shows a material useful as the support layer 124 of the embodiment of FIG. 2. It is a bi-directional screen 132 having an upper layer 133 of parallel strips secured to a lower layer 134 of parallel strips such that the strips of the upper layer 133 are arranged at an angle to the direction of the strips of the lower layer 134. The strips of the first layer 133 are arranged at an angle between about 5 and 1750 of the strips of the second layer 134. Preferably, the strips of the first layer 133 are arranged at an angle of between about 30 and 150° of the strips of the second layer 134, more preferably between about 60 and 120° of the strips of the second layer 134.

Alternatively, the support layer may be formed of a first layer of radially directed flat (non-lenticular) strips from a central portion with a second layer intersects one or both surfaces of the radial layer as a series of concentric rings of varying and progressively larger diameters as they get farther from the center of the layer. In another embodiment, the second layer may be formed of parallel strips.

The form of the support layer is not critical so long as it is self-supportive, flat (non-lenticular) and capable of maintaining that fluid pathway between the media and the central aperture in use.

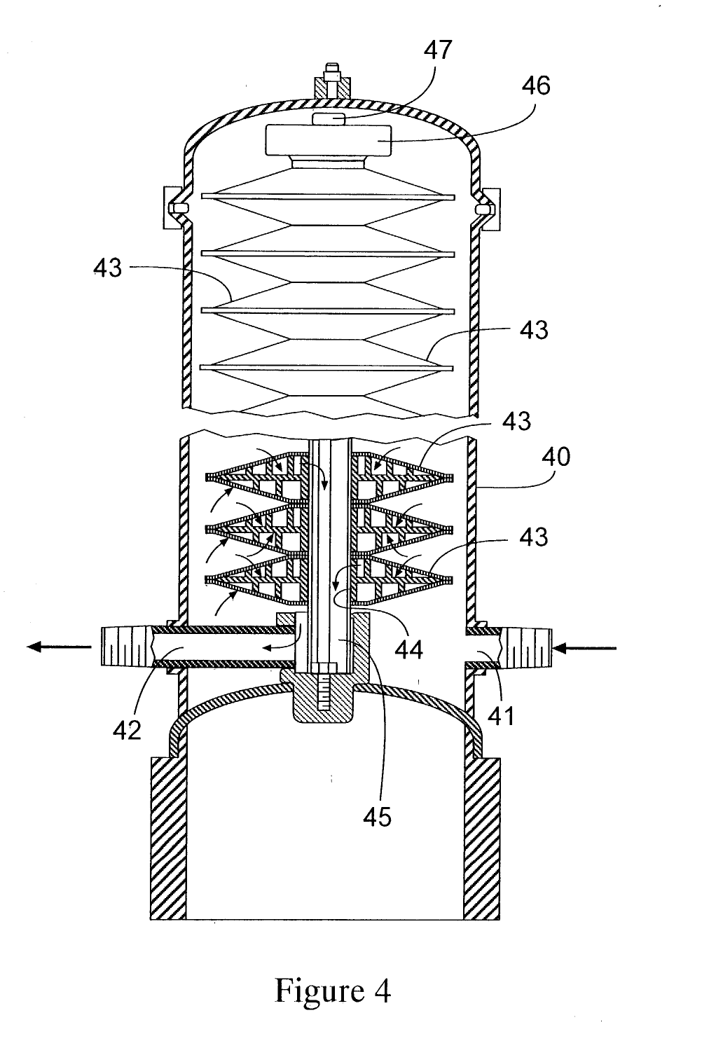

Screening, especially bi-directional screening is preferred due to its high flow and strength, low cost and the ability to simply purchase the material and not needing to make specially molded components such as lenticular ribs and connecting arcs. These screens have two layers of strips which are formed on top of each other. As shown in FIG. 4, they differ from traditional screen in that the strips of one layer do not weave over and under the other layer. Bi-directional screening is available from a variety of sources including US Netting.Inc, dba Naltex of Austin, Tex. Traditional screening (where one layer is woven over and under the other layer) can be used provided it meets the required levels of flow and strength.

A preferred bi-directional screen will use strips from about 0.046 inch (0.117 mm) to about 0.2 inch (5.08 mm) in thickness. The layer should be made of components thick enough to provide the flow and strength characteristics desired, preferably without losing the space advantage caused by the use of the flat material rather than the lenticular devices of the past.

The number of openings in a given area of structure can vary widely, but should enough to generate good flow at low pressure differentials and to be supportive of itself and the media imposed upon it. Typically they will have openings from about 3 mm by 3 mm to about 15 mm to about 15 mm. Generally, the higher the opening count per a given area, the smaller the openings, the greater the resistance to flow and the greater the strength. Conversely, the lower the openings number per given area, the greater the size of the openings and the greater the flow and the less strength imposed by the screen. One simply needs to balance these factors in selecting the correct sized screen.

Depending upon the angle selected between the two layers, one will get either a square or polygonal shape (such as a diamond design). Additionally, depending on whether the spacing between the strips of each layer is the same or different, one can form a square, rectangular or other polygonal shape.

FIG. 4 shows a filter assembly formed of a housing 40, having an inlet 41 and outlet 42 and a series of filtration devices 43 made according to the embodiments of either FIG. 1 or 2. The devices 43 are stacked on top of each other such that their central apertures 44 are all in a line so as to form a vertical conduit 45 that is connected to the outlet 42. Each of the apertures is formed to each other in a fluid-tight manner so that only fluid that has flowed through the filter device reaches the central aperture and outlet. The top 46 of the conduit 45 is closed by a cap 47 that also forms a fluid-tight sea[.

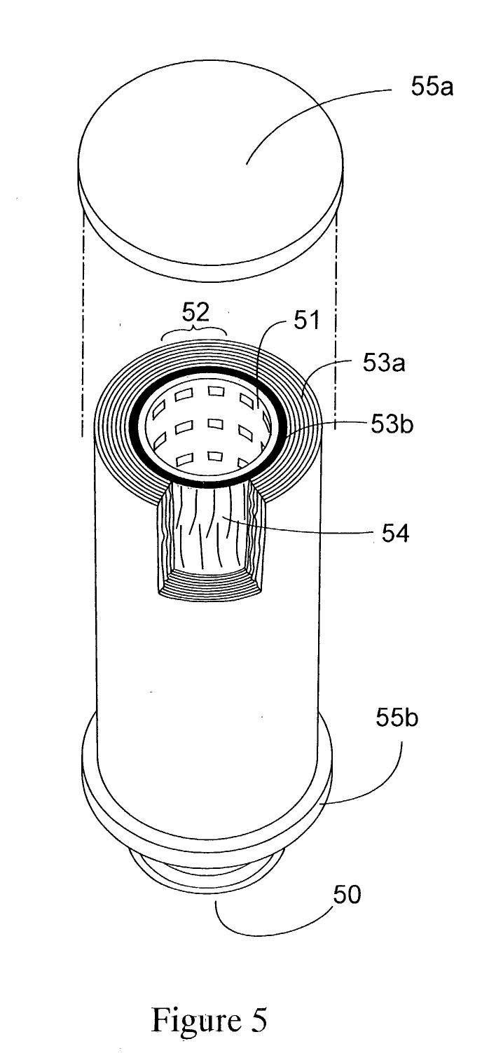

FIG. 5 shows another embodiment of the present invention. In this embodiment, the filter is in a more traditional filter configuration. It is comprised of an outlet 50 and a porous core 51 for collecting filtrate from the filter material (described below).

In this embodiment, the core 51 is liquid tightly sealed to the outlet 50 so that all liquid which enters the filter media 52 formed of one or more layers of porous media 53 and an elastomeric seal 54 formed on the upper and lower surfaces of the media so that all liquid to be filtered must flow through the filter media 52, then through the core 51 in order to reach the outlet 50. In this embodiment, outlet 50 is formed as part of the bottom cap 55B while the top cap 55A is solid and has no entry point in it.

While the core is shown as being attached to the outlet, if desired the core could be attached to the inlet and the corresponding filter layers set up such that the retentive layer is downstreammost. Additionally, this filter may be placed on a housing or use a separate inlet to introduce the fluid to the filter. Alternatively fluid could be run from the inside out with the filter media layers reversed so the retentive layer remains downstream.

The filter of this invention preferably comprises one or a plurality of media each having the same or different micron retention size. Representative media useful for forming the filter include the fiber of polyolefins such as polyethylene and/or polypropylene, cellulose including cellulose/diatomaceous earth or silica blends as are available from Millipore Corporation of Bedford, Mass. under the brand name MILLISTAK+™ filters and from Filter Materials of Waupaca, Wis. as well as cellulose derivatives such as cellulose acetate, cotton, polyamides, polyesters, fiberglass, polytetrafluoroethylene (PTFE), fluoropolymers such as PFA, MFA and FEP or the like. Cellulosic media or cellulosic composite media are preferred such as the MILLISTAK+™ filters. These materials and their methods of making them either by a wet process (similar to papermaking) or a dry process are well known in the art, See U.S. Pat. Nos. 5,928,588 and 4,007,113 and 4,007,114 for examples of making such media.

The filter can be formed from one or more layers of pads, sheets or disks (here after simply referred to as “sheets”) by stacking the sheets within a housing in a manner such that an open volume within the housing upstream of the filter. The filter sheet or sheets can have the same pore size or varying pore size such that the micron retention characteristic of a portion of the filter varies along the length of the housing. It is likely that multiple layers of stacked material could be positioned on either side of an inlet support to facilitate the use of different types of media.

If desired the porous media may be cast directly on to the support, using either the wet or dry process. Typically the layer or layers are formed individually and arranged on the surface of the central support and then attached to the central support by a liquid tight seal formed at the inner and outer periphery of the filter.

Likewise if more than one layer of porous media is used, they may be cast upon each other or they may be arranged as a group and sealed together as a unit by the elastomeric edge outer seals and the inner edge seal.

If desired one may use elastomeric seals at both the inner and outer edge of the filter.

Elastomer seals can be formed of a variety of material such as natural rubber, one or more synthetic rubbers, thermoplastic elastomers, thermoplastic vulcanates such as room temperature viulcanizable rubbers and the like. Thermoplastic elastomers are preferred, are well known and include SANTOPRENE® polymers, available from Advanced Elastomer Systems, L.P. of Akron, Ohio and SARLINK® polymers, preferably the 3135 version, a polypropylene thermoplastic elastomer available from DSM Thermoplastic Elastomers, Inc. of Leominster, Mass. and polypropylene with a blowing agent, (typically from 0.5 to about 2.0%).

The elastomeric material should be sufficiently resilient so as to accommodate the swelling of the media adjacent the outer edge and yet maintain a liquid tight seal. Typically, this ca is achieved with an elastomer that has a Shore A and a Shore D durometer of from about 30 to about 100, preferably from about 50 to 100 and more preferably from about 70 to about 100.

The elastomeric edge seal can be formed in a variety of ways. Preferably, it is molded to the edge as an overmolding. Alternatively, it can be preformed as a separate casting and then stretched over the edge of the support and media layers. Likewise, it can be applied as an extruded ribbon on the edge by rotating the edge adjacent an extruder that dispenses the ribbon of material into place. Other methods of formation as are known in the art for forming edge seals can also be used in forming the outer edge seal.

While not wishing to be bound to any particular mechanism by which the invention works, the Inventors offer the following comments. The elastomeric seals of the present invention help in maintaining the flatness of porous media and prevent buckling and cracking of the media during formation and use.

The typical pad device today is formed by laying the media on to a lenticular support, either as a dry preformed piece or in a wet lay process directly on the support. The outer edge is then sealed in a rigid rim that holds the edge of the media tightly in place. This edge is either a metal rim or more often a polypropylene overmolding such that the plastic extends over a portion of each face of the media on each side of the support as well as across the thickness of the device at its outer edge in a continuous piece. This rigid plastic also has high mold shrinkage so that after the overmold process the edge will shrink and cause the media to buckle. It is believed this happens as the media is very stiff and the shrinkage causes the media to bow upward from the center away from the central support. This causes issues of packing multiples of these devices in a housing as space between these buckled devices must be given, reducing the number of potential cells that can be used in a given housing. The elastomer edge of the present invention forms the liquid tight seal but is resilient and does not have the strength/force of a metal or rigid plastic edge to bow or buckle the media.

When the porous media is immersed in a liquid such as water or an aqueous stream, it increases in diameter (swells). If this diametrical growth is restricted, e.g. by a rigid overmold such as a hard plastic (polyethylene or polypropylene) or a metal edge, then the media will distort (buckle). The surface of the media will become wavy and non-planar and in some instances will crack or tear. The location and amount of the distortion is random. That is why the use of the rigid reinforced lenticular support has been so important. On the other hand, the elastomeric overmold of the present invention is pliant in nature. The overmold expands with the media, thereby significantly reducing or eliminating the distortion. As a result the media layers stay flat and do not tend to buckle, distort or crack and can if desired reduce or eliminate the need for the lenticular support currently used in such devices.

Additionally, as the edge seal expands with the media, the media expansion is generally uniform from layer to layer and the spacing between layers can be reduced as one knows the relative expansion that will occur in each layer and can space the layers accordingly to provide optimal fluid flow and minimize space between adjoining layers. Likewise, the reduction or elimination of the lenticular support structure allows one to further reduce the space between layers, resulting in higher capacity for a given volume of area.

What we claim:

1) A porous filter comprising a central support layer having a first and a second support surface, one or more layers of porous fibrous media mounted to each of the first and second support surface and an elastomeric outer seal formed over the one or more layers of media and the central support layer to form a liquid tight seal at the outer edge.

2) The filter of claim 1 wherein the support structure has a central aperture for the passage of filtered fluid, two opposed support disks having upper and lower surfaces, said disks being spaced apart from each other so as to define a channel between the inner surfaces of the disks, said channel being in fluid communication with the central aperture of the support structure, the support disks emanating radially outward from said central aperture, each disk having one or more openings from its outer surface to its inner surface, said one or more layers of porous media attached to the outer surfaces of the support disks and an outer peripheral, liquid tight seal edge formed of an elastomeric material circumscribing each support disk and one or more layers of porous media so that all fluid reaching the channel must flow through the porous media.

3) A filtration system comprising a housing having a removable member to provide access to the interior of the housing, an inlet and an outlet to and from the interior thereof, an assembly formed of a plurality of filter cells through which fluids are passed for filtration, each said cell having a central support structure, a central aperture there through for the passage of fluid, one or more opposed disks of filtration media on an upper and lower surface of the central support structure, the support and the disks emanating radially from said central aperture and an outer peripheral edge circumscribing each said cell, said central aperture of cells being contiguously juxtaposed to define an open central core of said assembly having opposed first and second ends, said first end being attached to the outlet of the housing, said second end being closed, wherein the outer peripheral edge is in the form of an elastomeric seal sealing the support and media disks so that all fluid reaching the channel must flow through the porous media.

4) The system of claim 3 wherein the support is lenticular in form.

5) The system of claim 3 wherein the support is relatively flat in form.

6) The system of claim 3 wherein the support is relatively flat in form and is formed of a bi-directional screen.

7) The system of claim 1 wherein the support is lenticular in form.

8) The system of claim 1 wherein the support is relatively flat in form.

9) The system of claim 1 wherein the elastomeric seal is formed of an elastomeric material selected from the group consisting of natural rubber, synthetic rubber, thermoplastic elastomer, thermoplastic vulcanates, thermoplastic/blowing agent and blends thereof.

10) The system of claim 3 wherein the elastomeric seal is formed of an elastomeric material selected from the group consisting of natural rubber, synthetic rubber, thermoplastic elastomer, thermoplastic vulcanates, thermoplastic/blowing agent and blends thereof.

11) The system of claim 1 wherein the elastomeric seal is formed by overmolding.

12) The system of claim 3 wherein the elastomeric seal is formed by overmolding.

13) A filter comprising a housing having an inlet and an outlet, a porous core liquid tightly sealed to the outlet such that all liquid entering the inlet of the housing must pass through the core to reach the outlet, one or more porous fibrous media attached to the upstream side of the core in a liquid tight seal such that all liquid entering the inlet of the housing must pass through the one or more layers of porous fibrous media to reach the core and wherein the one or more fibrous media layers are sealed by one or more elastomeric layers.

14) A filtration system comprising a housing having a removable member to provide access to the interior of the housing, an inlet and an outlet to and from the interior thereof, an assembly formed of a plurality of filter cells through which fluids are passed for filtration, each said cell having a central aperture there through for the passage of fluid, one or more opposed disks of filtration media, spaced apart and defining upper and lower surfaces of each said cell emanating radially from said central aperture, and an outer peripheral edge circumscribing each said cell, the outer edge being formed of an elastomeric material, said central aperture of cells being contiguously juxtaposed to define an open central core of said assembly having opposed first and second ends, said first end being attached to the outlet of the housing, said second end being closed, each cell being formed of central support layer and one or more layers of porous fibrous media upstream of both sides of the central support layer.

15) The system of claim 14 wherein the central support layer is formed of one or more layers of bi-directional screen.

16) The system of claim 14 wherein the central support layer is formed of a lenticular structure.

17) The system of claim 14 wherein the elastomeric seal is formed of an elastomeric material selected from the group consisting of natural rubber, synthetic rubber, thermoplastic elastomer, thermoplastic vulcanates, thermoplastic/blowing agent and blends thereof.
